(19) United States
(12) Patent Application Publication
(10) Pub. No.: US 2014/0179018 A1
(43) Pub. Date: Jun. 26, 2014

(54) METHOD FOR ANALYZING HALOGEN OXOACIDS

(71) Applicants: Jun Watanabe, Ritto-shi (JP); Keiko Matsumoto, Ibaraki-shi (JP)

(72) Inventors: Jun Watanabe, Ritto-shi (JP); Keiko Matsumoto, Ibaraki-shi (JP)

(73) Assignee: SHIMADZU CORPORATION, Kyoto-shi, Kyoto (JP)

(21) Appl. No.: 14/238,228

(22) PCT Filed: Aug. 12, 2011
(86) PCT No.: PCT/JP2011/068456

§ 371 Date: Feb. 18, 2014

(51) Int. Cl. G01N 30/02

(52) U.S. Cl. CPC G01N 30/02
USPC 436/161

(57) ABSTRACT

To quantitatively analyze halogen oxoacids such as bromic acid and perchloric acid, an HPLC/MS in which a mass spectrometer is connected to the outlet of a column of a high performance liquid chromatograph (HPLC) is used, and by using a reverse-phase column having an ion exchange function as the column, as well as a mixed liquid of an ammonium formate buffer solution and acetonitrile as the mobile phase, gradient analysis in which the concentration of ammonium formate in ammonium formate/acetonitrile is increased is performed. Thereby, a common HPLC/MS apparatus configuration using no suppressor makes it possible to appropriately separate various halogen oxoacids and other components contained in a sample and to detect them at high sensitivity.

### TECHNICAL FIELD

The present invention relates to a method for analyzing halogen oxoacids such as perchloric acid, chloric acid, bromic acid, and iodic acid at high sensitivity.

### BACKGROUND ART

As the advanced ozone treatment prevails on tap water, the effects of halogen oxoacids generated as by-products in the treatment, such as bromic acid and perchloric acid, on health has become a concern. Particularly, bromic acid has a problem of carcinogenicity. In recent years in Japan, the regulation on the content of bromic acid in tap water has been tightened. Along with such tightening of the regulation or an increasing concern about contamination of the living environment such as river water, higher sensitivity and higher accuracy in quantitative analysis of halogen oxoacids have been required.

Since halogen oxoacids exist as halogen oxoacid ions in solutions such as an aqueous solution, ion chromatography employing a conductivity detector as the detector has been conventionally used for the quantitative analysis (refer to JP-A 2002-249517, for example). Ion chromatography is a separation method that employs a column containing ion exchange resin as the stationary phase, and an electrolyte solution as the mobile phase. Depending on the difference in the ion exchange capacities (selectivity coefficients) between various ions existing in a sample solution and the ion exchange resin, each ion is separated and eluted from the column. However, with such a conventional analyzing approach, it is difficult to measure a trace amount of halogen oxoacids, and the measurement accuracy is not satisfactory. Since pretreatment of the sample such as condensation to increase the concentration of the subject component to be analyzed is essential to enhance the detection sensitivity, it is difficult to enhance throughput of the analysis.

To cope with such problems, a method for analyzing halogen oxoacids with ion chromatography using an electrospray ionization (ESI) mass spectrometer as the detector is proposed in Non-Patent Document 1. FIG. 3 is a schematic configuration diagram of the analysis apparatus according to the proposed method.

In this apparatus, a mobile phase (potassium hydroxide) sucked by a liquid delivery pump 12 from a mobile phase vessel 11 is flowed through an injector 13 to an ion exchange column 14. When a sample containing bromine, bromic acid, chloric acid, perchloric acid, or the like is introduced from the injector 13 into the mobile phase, these components are separated during passage through the ion exchange column 14 and eluted from it. The mobile phase contains a non-volatile salt at a high concentration. To avoid the salt to come into the mass spectrometer 17, a suppressor 15 is inserted between the ion exchange column 14 and the mass spectrometer 17. By removing ions in the mobile phase, the suppressor 15 reduces the background noise, and prevents clogging of the ESI spray nozzle due to deposition of salt derived from the mobile phase. However, passage through the suppressor 15 may increase the polarity of the solution and lower the ionization efficiency. Thus, to increase the ionization efficiency, at a methanol addition unit 16, methanol at a constant flow rate is added to the mobile phase. In the mass spectrometer 17, MRM measurement is performed in the negative ionization mode to obtain a mass chromatogram (extracted ion chromatogram) corresponding to each component.

Using a mass spectrometer as the detector, as described above, even if impurities that cannot be adequately separated in the ion exchange column are eluted together with the object component, the object component can be properly detected owing to the difference in the mass-to-charge ratios. Additionally, combination of the mass spectrometer 17 and the suppressor 15 makes it possible to detect the object component at higher sensitivity than with a conductivity detector.

However, in the aforementioned analyzing method, it is necessary not only to insert the suppressor 15 between the ion exchange column 14 and the mass spectrometer 17, but also to add organic solvents such as methanol at a constant flow rate into the flow path from the suppressor 15 to the mass spectrometer 17. This necessitates modification of the apparatus configuration of normal high performance liquid chromatograph-mass spectrometers (HPLC/MS) now widely used. When tap water, river water, or the like is tested, for example, various substances other than halogen oxoacids are also quantitatively analyzed. When such complicated operation of modifying the apparatus configuration is done only when halogen oxoacids are analyzed, it is a major obstacle to the analysis efficiency. Additionally, potassium hydroxide used as the mobile phase is designated as a dangerous chemical in Japan so that it requires careful handling. Use of such a substance as the mobile phase will be also an obstacle to efficient analysis operations.

### BACKGROUND ART DOCUMENT

### Patent Document

[Patent Document 1] JP-A 2002-249517

### Non-Patent Document

[Non-patent Document 1] “Highly sensitive analysis of bromine and halogen oxoacids with Agilent 6410” [online], Agilent Technologies, Inc. [Searched on Aug. 8th, 2011], Internet <URL: http://www.chem-agilent.com/cimg/LCMS-200809TK-001.pdf>

### DISCLOSURE OF THE INVENTION

### Problems to be Solved by the Invention

The present invention has been developed to solve the aforementioned problems. The main objective of the present invention is to provide a method for analyzing halogen oxoacids that is simpler than the aforementioned conventional approach and is capable of quantitatively analyzing halogen oxoacids at high sensitivity and high accuracy using a common, normal high performance liquid chromatograph mass spectrometer.

### Means for Solving the Problems

The previously-described combination of a mobile phase containing a high concentration of non-volatile salt, an ion exchange column, and a mass spectrometer can attain high detection sensitivity. However, a suppressor to remove undesired ions is inevitable. To avoid the use of suppressor, a mobile phase not containing high concentration non-volatile salt must be used. Thus, the present inventors has arrived at use of a column having hydrophobic properties substantially comparable or close to those of a common reverse-phase column (reverse-phase chromatography column) and having an ion exchange function so as to hold ionic highly polar substances, instead of an ion exchange column. Then, the inventor has repeated experimental studies, using such a column, on the analysis conditions including mobile phases, and has found that halogen oxoacids such as bromic acid and perchloric acid can be properly separated, and high detection sensitivity and high quantitative properties can be achieved, by use of, as the mobile phase, a mixed liquid of an organic acid salt buffer solution or the like and an organic solvent.

The method for analyzing halogen oxoacids according to the present invention, which has been developed based on the findings as aforementioned, is a method for quantitatively analyzing halogen oxoacids in a sample, wherein a liquid chromatograph-mass spectrometer is used in which a column of high performance liquid chromatography is connected to an atmospheric-pressure ionization mass spectrometer, and wherein a reverse-phase column having an ion exchange function is used as the column, and a mixed liquid of an organic acid or organic acid salt buffer solution and an organic solvent is used as the mobile phase, whereby various components including halogen oxoacids in the sample are separated and then detected.

Generally, “organic acids” means carboxylic acids including acetic acid, formic acid, oxalic acid, lactic acid, tartaric acid, citric acid and trifluoroacetic acid. As the aforementioned organic acid salt buffer solution, ammonium formate buffer solutions or ammonium acetate buffer solutions may be used, for example. A typical example of the aforementioned organic solvent is acetonitrile, but is not limited to it.

Thus, in one aspect of the present invention, the mobile phase can be a mixed liquid of an ammonium formate buffer solution and acetonitrile. In this case, it is beneficial to perform gradient analysis in which the concentration of ammonium formate is increased with time.

For example, ammonium formate, which contains positively-charged ammonium ions and negatively-charged formate ions, contributes to an action to hold halogen oxoacid ions in the sample by the ion exchange function of the stationary phase in the column. Additionally, since organic acid salt buffer solutions such as ammonium formate are volatile salts, the buffer solutions cause less problem of deposition when they are introduced into the mass spectrometer, specifically the ESI ion source, for example. Organic solvents such as acetonitrile are polar solvents, and contribute to the hydrophobic interaction (that is, a reverse-phase function) of the stationary phase in the column. It further contribute to efficient ionization of sample molecules in the mass spectrometer, specifically in the ESI source, for example.

Various aspects of the aforementioned “reverse-phase column having an ion exchange function” may be contemplated. Specifically, it is possible to employ a column containing, as the stationary phase, a packing material such as porous silica on the surface of which ODS (OctaDecylSilyl) groups, for example, and ion receptors are introduced. It is also possible to employ a column packed with, for example, a mixture of a packing material for reverse-phase chromatography on the surface of which ODS groups are introduced and a packing material for ion chromatography (or ion exchange chromatography) such as an ion exchange resin. Since either of the columns have both the component separation function by ion exchange and the component separation function of the reverse-phase mode, not only ions derived from halogen oxoacids, which are strongly ionic compounds in the sample, but also non-ionic compounds can be separated.

### Effects of the Invention

In accordance with the method for analyzing halogen oxoacids according to the present invention, it is neither necessary to insert a suppressor between the column and the mass spectrometer nor it is necessary to add an organic solvent into the flow path between the suppressor and the mass spectrometer. Thus, the analysis can be performed with a common apparatus configuration for a high performance liquid chromatograph-mass spectrometer. Accordingly, even when analysis of substances other than halogen oxoacids is performed, the apparatus configuration does not need to be modified every time, and analysis operations do not become complicated. This is advantageous to enhance the throughput. Since common mobile phases which is easy to handle can be used, the analysis operations are simple in this point.

### BRIEF DESCRIPTION OF THE DRAWINGS

FIG. 1 is a schematic configuration diagram of one example of a high performance liquid chromatograph-mass spectrometer (HPLC/MS) for implementing the method for analyzing halogen oxoacids according to the present invention.

FIG. 2 shows an example of analysis in the HPLC/MS of the present embodiment.

FIG. 3 is a schematic configuration diagram of the conventional ion chromatograph-mass spectrometer for analyzing halogen oxoacids.

### MODE FOR CARRYING OUT THE INVENTION

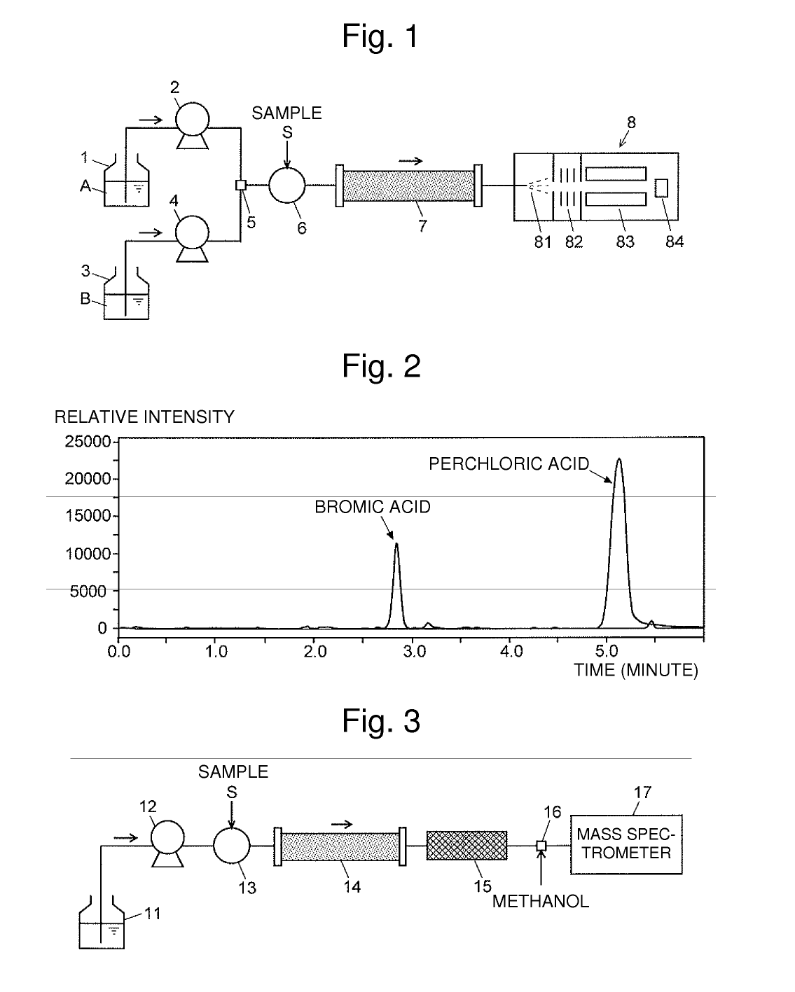

One embodiment of the method for analyzing halogen oxoacids according to the present invention will be described. FIG. 1 is a schematic configuration diagram of an example of an HPLC/MS for implementing the analysis method according to the present invention.

In FIG. 1, a first liquid delivery pump 2 flows a mobile phase A from a first mobile phase reservoir 1 and supplies the mobile phase A at the constant flow rate, and a second liquid delivery pump 4 flows a mobile phase B from a second mobile phase reservoir 3 and supplies the mobile phase B at the constant flow rate. The mobile phase A and the mobile phase B are mixed in a mixer 5, and the mixture is supplied through an injector 6 to a column 7 In the injector 6, a liquid sample, which is the subject to be analyzed, is injected into the mobile phase using a microsyringe and the like. The liquid sample is supplied on the flow of the mobile phase into the column 7. Various components in the sample are separated during flow path through the column 7 and are eluted from the outlet of the column 7 at different time points.

The eluate from the column 7 is supplied to a mass spectrometer 8 as the detector, and is sprayed from a spray nozzle of an ESI ion source 81 into a nearly atmospheric-pressure atmosphere. The component molecules contained in the eluate are ionized. The produced ions converge on an ion lens 82, and are separated with a quadrupole mass filter 83 in accordance with the mass-to-charge ratios, and arrive at an ion detector 84, where the ions are detected. As time passes, the types of the components contained in an eluate, that is, the types of components to be subjected to mass spectrometry change. The quadrupole mass filter 83 is driven in the selective ion monitoring (SIM) mode so as to detect ions of one or more preset mass-to-charge ratios. Accordingly, detection signals obtained at the ion detector 84 reflect each component. In a data processor (not illustrated), a mass chromatogram corresponding to a halogen oxoacid, which is the object component, is created based on the detected signal. Based on the peaks that appear on the chromatogram, the object component is qualitatively and quantitatively analyzed.

It should be noted that the ion source of the mass spectrometer 8 is not limited to that based on the ESI, and may be that based on the Atmospheric Pressure Chemical Ionization (APCI) and that based on the Atmospheric Pressure Photoionization (APPI). Alternatively, the mass separator may not be a quadrupole mass filter, and may be, for example, a Time-of-Flight mass spectrometer and the like. Alternatively, the mass separator may be a mass spectrometer capable of performing MS/MS analysis or MSⁿ analysis, such as a triple-quadrupole mass spectrometer.

In an HPLC/MS used in the method for analyzing halogen oxoacids according to the present invention, the column 7 and the mass spectrometer 8 are directly connected, and no apparatus to provide some kind of treatment on the solution, such as a suppressor is installed between them. As the column 7 of the HPLC, not an ion exchange column, but a column into which a stationary phase having both an ion exchange function and a component separation function in the reverse-phase mode (that is, a function of separating components by a hydrophobic interaction) is packed is used. Specifically, for example, Scherzo C18 series produced by Imtakt Corporation (See <URL: http://www.imtakt.com/jp/Products/Scherzo/index.htm>) can be used. This is a column into which porous silica is packed as the stationary phase, wherein the surface of the silica is modified with functional groups having an ion exchange function (ion receptors) and ODSs. In addition to these, it is also possible to use such a column that a mixture of a reverse-phase chromatography packing material on the surface of which ODS groups are introduced and an ion chromatography packing material such as ion exchange resins is packed into.

In the aforementioned column, to separate basic substances and non-ionic substances in addition to ions of halogen oxoacids, which are strongly ionic compounds, a mobile phase in which, for example, an organic acid salt buffer solution such as an ammonium formate or ammonium acetate buffer solution and an organic solvent such as acetonitrile are mixed is used. However, to appropriately separate different halogen oxoacids such as bromic acid and perchloric acid, gradient analysis, in which the concentration of the organic acid salt buffer solution is changed with time, is performed. Thus, in this example, gradient analysis is performed by using ammonium formate at the constant concentration as the mobile phase A, and a mixed liquid of ammonium formate at a sufficiently higher concentration than the concentration of the ammonium formate of the mobile phase A and acetonitrile as the mobile phase B, and by gradually increasing the mixed ratio of the mobile phase B from a low ratio, for example 0%.

In the presence of formate ions and ammonium ions derived from ammonium formate, which is a volatile salt, the halogen oxoacid ions in the sample are retained by the ion receptors of the column 7. Furthermore, as the increase in concentration of ammonium formate, differences in the retention capacity for different types of halogen oxoacid ions are increased, and the different types of halogen oxoacids are eluted from the column 7 at sufficiently different time points. On the other hand, nonionic compounds contained in the sample are separated due to the hydrophobic interaction of ODS. Accordingly, by the combination of the aforementioned mobile phase and the column 7, various components contained in the sample, including nonionic compounds in addition to different types of halogen oxoacids, are separated. In the state where acetonitrile is not contained in the mobile phase, the polarity of the mobile phase is high and the ionization efficiency in the ESI ion source 81 is not very high. When acetonitrile is added to the mobile phase to lower the polarity, the ionization efficiency in the ESI ion source 81 is increased. Thereby, in the mass spectrometer 8, it is possible to efficiently ionize various components contained in the eluate from the column 7 and to perform analysis at high sensitivity. Additionally, since ammonium formate is volatile, if introduced into the ESI ion source 81, the risk of causing clogging is low.

### EMBODIMENT

A specific analysis example of halogen oxoacids using the HPLC/MS shown in FIG. 1 is described.

The analysis conditions are as follows:

Apparatus: LCMS-8030 (produced by SHIMADZU CORPORATION)

Column: Scherzo SM-C18 produced by Imtakt Corporation (inner diameter 2.0 mm, length 50 mm, packed material particle diameter 3 m)

Mobile phase A: 1 mM ammonium formate buffer solution

Mobile phase B: 100 mM ammonium formate buffer solution+acetonitrile (mixed ratio 1:9)

Column flow rate: 0.25 mL/min

Gradient time program: 0% (0 minute)-60% (6.0 minute) mobile phase B

Column temperature: 35° C.

The ionization method in the mass spectrometer 8 is performed in the negative ion mode.

Under the aforementioned analysis conditions, as samples, a standard grade of perchloric acid (10 ppb) and a standard grade of bromic acid (100 ppb) were measured and detected. The resulting mass chromatograms are shown in FIG. 2. From FIG. 2, it can be seen that perchloric acid and bromic acid are detected with a sufficient difference of retention times and that there appears almost no background interfering with the quantification. This is because the measured data resulted from using a triple-quadrupole mass spectrometer and the MRM measurement of the triple-quadrupole mass spectrometer is highly selective. This result can confirm that a performance sufficient to quantify bromic acid, perchloric acid and the like contained in tap water, river water and the like can be secured.

It is noted that the aforementioned embodiment is one example according to the present invention and it is evident that any modification, change or addition appropriately made within the spirit of the present invention will fall within the scope of the appended claims.

### EXPLANATION OF NUMERALS

1 . . . First mobile phase reservoir
2 . . . First mobile phase delivery pump
3 . . . Second mobile phase reservoir
4 . . . Second mobile phase delivery pump
5 . . . Mixer
6 . . . Injector
7 . . . Column
8 . . . Mass spectrometer
81 . . . ESI ion source
82 . . . Ion lens
83 . . . Quadrupole mass filter
84 . . . Ion detector

1. A method for analyzing halogen oxoacids, wherein the halogen oxoacids in a sample are quantitatively analyzed,
wherein a liquid chromatograph-mass spectrometer is used in which a column of high performance liquid chromatography is connected to an atmospheric-pressure ionization mass spectrometer, and
wherein a reverse-phase column having an ion exchange function is used as the column, and a mixed liquid of an organic acid or organic acid salt buffer solution and an organic solvent is used as the mobile phase, whereby various components including halogen oxoacids in the sample are separated and then detected.

2. The method for analyzing halogen oxoacids according to claim 1,
wherein the column has a packing material as the stationary phase on the surface of which ODS groups and ion receptors are introduced.

3. The method for analyzing halogen oxoacids according to claim 1,
wherein the mobile phase is a mixed liquid of an ammonium formate buffer solution and acetonitrile, and gradient analysis in which the concentration of ammonium formate is increased with time is performed.

4. The method for analyzing halogen oxoacids according to claim 2,
wherein the mobile phase is a mixed liquid of an ammonium formate buffer solution and acetonitrile, and gradient analysis in which the concentration of ammonium formate is increased with time is performed.
